(19) United States
(12) Patent Application Publication
(10) Pub. No.: US 2013/0185291 A1
(43) Pub. Date: Jul. 18, 2013

(54) ONLINE RATING AND FEEDBACK SYSTEM

(71) Applicant: Mat Tyndall, San Francisco, CA (US)

(72) Inventor: Mat Tyndall, San Francisco, CA (US)

(21) Appl. No.: 13/548,097

(22) Filed: Jul. 12, 2012

Related U.S. Application Data
(60) Provisional application No. 61/506,724, filed on Jul. 12, 2011.

(51) Int. Cl. G06F 17/30

(52) U.S. Cl. CPC G06F 17/30598
USPC 707/723; 707/737; 707/740

(57) ABSTRACT

The present invention provides, in at least one embodiment, a system and method to improve the rating process by asking for feedback through a simple tag interface, which allows a user to rate content. The tag interface has an overall rating and at least one tag to be rated by the user. The user's rating of the tag helps classify the content for other users and the system forming a link between the user's overall rating and tag rating indicates the user's tastes. By systematically asking the users to evaluate a small subset of qualities in the form of tags, as opposed to asking each user to evaluate a large amount of tags, the system pieces together a large understanding of the content in a way that is very simple for the users.

### CROSS REFERENCE TO RELATED APPLICATIONS

This application claims priority under 35 U.S.C. §119(e) to U.S. Provisional Application No. 61/506,724, filed Jul. 12, 2011, and entitled “Online Rating and Feedback System,” the disclosure of which is hereby incorporated by reference in its entirety.

### BACKGROUND OF THE INVENTION

1. Field of Invention

The invention relates generally to a method and system for rating network content and more particularly, to tags for rating content available via the Internet.

2. Description of Related Art

Historically, rating and feedback systems have been used to help consumers predict whether content will be right for them. For example, movies are reviewed by critics and the Motion Picture Association of America (MPAA). The MPAA uses a film-rating system to rate a movie's suitability for certain audiences, helping guide parents on which movies are appropriate for their children. Similarly, television shows and video games have ratings to help parents determine if the content is suitable for their children and to help consumers determine if the content is right for them. Netflix allows viewers to rate movies from one (i.e., strongly disliked) to six stars (i.e., strongly liked).

For radio, Pandora radio utilizes user ratings to provide automated music recommendations to the user. In Pandora, a user enters a song or artist that they enjoy, and the service responds by playing selections that are musically similar (e.g., based on objective music qualities such as a quick tempo). Users provide feedback on their approval or disapproval of individual songs, which Pandora takes into account for future selections.

For aggregating news stories online, Digg is a social news website which allows readers to vote stories up or down, called digging and burying, respectively, to allow other users to determine which articles are worth reading. Digg's main competitor, Reddit, is a social news website which gives users the option to submit links to content on the Internet or submit self-posts that contain original user-submitted text. Other users may then vote the posted links up or down, with the most successful links gaining prominence by reaching the front page. In addition, users can comment on the posted links and reply to other commentators, consequently forming an online community.

Delicious is another social website, which is known for its bookmarking web service. Delicious allows users to store, share, and discover web bookmarks. Delicious uses a non-hierarchical classification system in which users can tag each of their bookmarks with freely chosen index terms. A combined view of everyone's bookmarks with a given tag is available. The website's collective nature makes it possible to view bookmarks added by other users.

Another website, Hunch, is designed as a collective intelligence decision-making system that uses decision trees to make decisions based on users' interests. Hunch maps every user to every entity, and to the user's affinity for that entity. The system asks the users a series of questions about a topic. Upon completion of the questions, the users are presented with results, where they can agree or disagree with the results to help train the system. Users can also add pros and cons about the results.

Disqus is an online service that offers a centralized discussion platform for website comments. Disqus supports integration with other social networking websites, such as Facebook and Twitter, and reporting websites such as CNN, Fox News, and the Daily Telegraph. When a user posts a comment on one of the websites that uses Disqus, the comment is submitted to Disqus. If the user has a Disqus account, then it tracks all their comments across the websites that use Disqus.

Similarly, Facebook Connect also collects online comments from users. Facebook Connect includes an Application Programming Interface (API), which is a particular set of rules and specifications that software programs can follow to communicate with each other or lower level operating systems, similar to the way a computer's user interface facilitates interaction between humans and computers. Facebook Connect's API enables Facebook members to log on to third-party websites, applications, mobile devices, and gaming systems with their Facebook identity. While logged in, users can connect with friends and post information and updates to their Facebook profile. Developers can use these services to help their users connect and share information with their Facebook friends on and off of Facebook and increase engagement for their website or application.

Others systems focus on creating better algorithms that extract more useful information from the given data that is collected from users. However, making improvements to these algorithms has been getting progressively more difficult. For example, the Netflix Prize Challenge awarded one million dollars to the winner, who was only able to make a 10% improvement to a particular recommendation algorithm. So, instead of a system that focuses on incremental improvements in algorithms, it would be desirable to have a system that collects better data from users, as there is more room for improvement there.

User generated content is being created online at an exponentially increasing rate, from sources such as, but not limited to blogs, videos on YouTube, tweets on Twitter, and comments on news websites. Conventional methods of collecting feedback and organizing data either are not comprehensive enough to accurately classify this content or are not simple or compelling enough to get users to rate the content. The only way to keep this flood of content under control is to tap into the users themselves. The users can then rate, manage, and categorize the content as it is generated. Existing websites and application programming interfaces have incomplete solutions to these problems.

The prior art systems attempt to effectively categorize and recommend content to users, but they fall short, since the systems are either too complicated or not comprehensive enough. For example, Digg provides a simple interface that allows users to vote a story up or down, but lacks the comprehensive qualities to determine more than a user's simple like or dislike of the news story. Hunch, on the other hand, obtains comprehensive feedback by asking users a series of questions like a personality test, but is not a simple interface, which limits the number of users who will provide feedback. Because of these noted shortcomings, an improved system and method is needed to create a rating system that is both simple and comprehensive.

### SUMMARY OF THE INVENTION

The present invention overcomes these and other deficiencies of the prior art by providing a data platform for the next generation of the Internet, which is waiting to be developed once a rating system is developed that can keep up with the rapidly developing content generated by users and websites. The system comprises a simple tag interface that provides more meaningful and comprehensive feedback for online content. The content is subjectively and objectively rated for more organized content, more tailored recommendations, and better predictions on which content is right for individual users.

An advantage of the present invention is that it provides more meaningful feedback, because the content can be rated on a wide variety of tags, enabling the system to better predict who that content is right for. The meaningful feedback is useful to the user rating the content, other users, and website owners seeking to improve their website and provide targeted advertisements.

Also, the system is advantageously simpler than other systems that provide meaningful feedback, since the system does not require a user to prepare a comment or answer a long series of questions in order to classify the content. The system uses the simplest method for collecting information, which minimizes the participation barrier that prevents users from providing ratings. As a result, more users will provide ratings. Also, the tag interface is intuitive, unlike many prior systems, such that a new user can jump right in and understand the system. Further, the user can rate content with or without registering and without reading any instructions. The system also provides more tailored recommendations, making customers more willing to rate content.

The system is much better than conventional systems (e.g., 5-stars, up/down rating, like/dislike voting, etc.) because the ratings in conventional systems provide insufficient detail to understand why a user likes or dislikes something. Also, the system provides a process that is more interactive and provides better feedback and incentives to users. Further, the system optionally allows the user to add a follow up rating, where a follow-up rating allows the user to dynamically add more detail to their ratings by simply rating more times.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, and the advantages thereof, reference is now made to the ensuing descriptions taken in connection with the accompanying drawings briefly described as follows:

FIG. 1 illustrates a system for online rating and feedback according to an embodiment of the invention;

FIG. 2 illustrates a tag interface in the system according to an embodiment of the invention; and

FIG. 3 illustrates a process of rating content according to an embodiment of the invention.

### DETAILED DESCRIPTION OF EMBODIMENTS

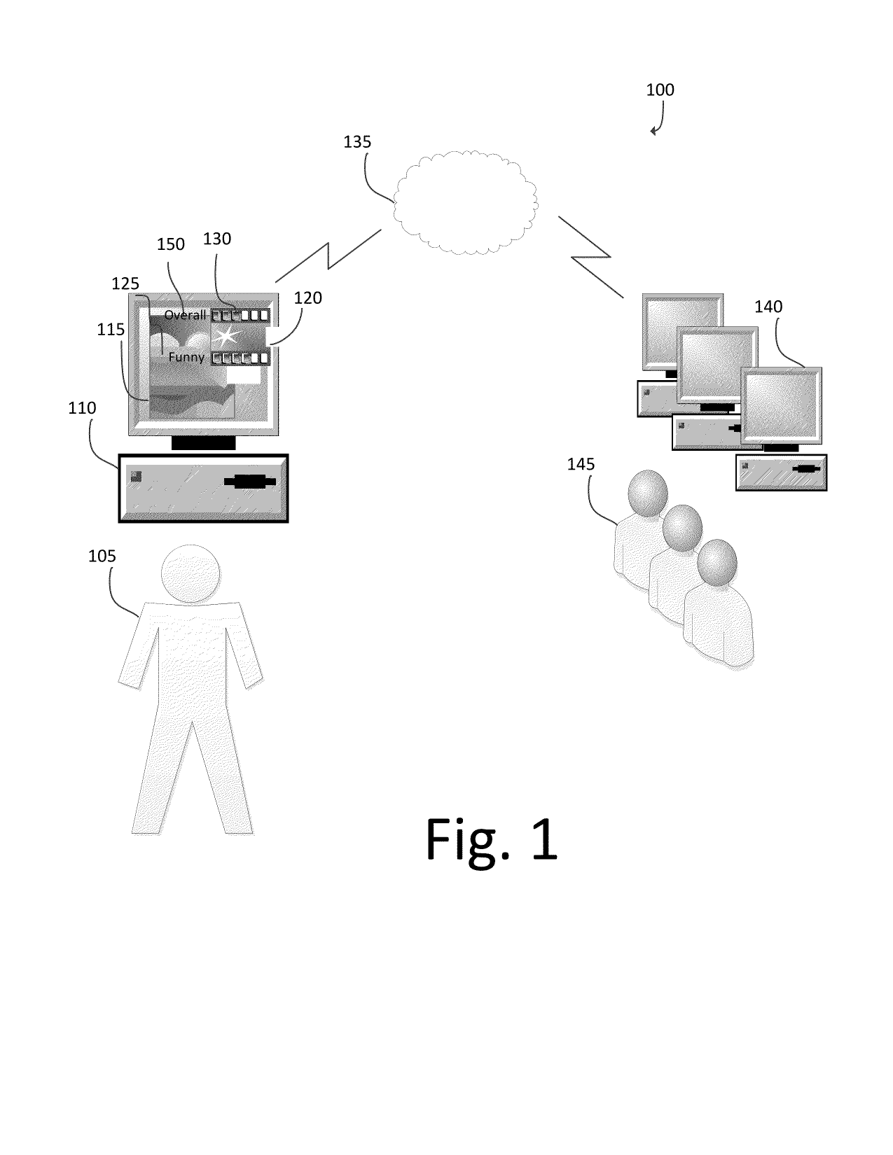

Further features and advantages of the invention, as well as the structure and operation of various embodiments of the invention, are described in detail below with reference to the accompanying FIGS. 1-3, wherein like reference numerals refer to like elements. Although the invention is sometimes illustrated and described in the context of content ratings on an Internet enabled computer, one of ordinary skill in the art can apply these concepts to other network and feedback systems and terminals, such as network content viewed by a mobile phone (e.g., a digital application, such as an iPhone app) and viewed on a television (e.g., a streaming video provided by a company such as Hulu or Netflix). Although the invention is sometimes described in terms of tagging, this system can alternatively rate content using questions and ratings. Questions and ratings can be less confusing to users since they are more explicit than tags but are functionally almost the same to the system.

The present invention provides, in at least one embodiment, a system and method to improve the rating process by asking for feedback through a simple tag interface, which allows a user to rate content. The tag interface has an overall rating and at least one tag to be rated by the user. The user's rating of the tag helps classify the content for other users and the system forming a link between the user's overall rating and tag ratings indicating a particular user's tastes. By systematically asking the users to evaluate a small subset of different and various qualities in the form of tags, as opposed to asking each user to evaluate a large amount of tags or come up with the tags themselves, the system pieces together a large understanding of the content in a way that is very efficient and simple to implement for users.

For example, if a user answers a follow up question or rates a movie as very scary, but gives a low overall rating, this is evidence that the user does not like scary movies. After the ratings are combined, the system provides more meaningful feedback of the content for other users and better predictions for future content recommendations to the user. Thus, the present invention provides a form of contextualism missing from conventional rating systems.

FIG. 1 illustrates a system 100 for online rating and feedback according to an embodiment of the invention. The system 100 comprises a user 105, a terminal 110, content 115, a tag interface 120 having an overall rating 150 and one or more tags 125, each having a rating 130, a network 135, other terminals 140, and other users 145. The system 100 provides a simpler interface and more meaningful feedback to better predict which content is right for users.

The user 105 watches, listens, or interacts with the content 115 on the terminal 110. The terminal 110 is illustrated as a computer, but could also be another electronic device (e.g., a smartphone, a television, a MP3 player, etc.). The content 115 includes websites and content on the websites, such as links, comments, tweets, movies, blogs, pictures, news sites, recommendation systems, e-commerce, information from social networking applications, etc. The content 115 can be provided to the user 105 via the network 135 (e.g., the Internet). The content 115 includes, among other things, movies streamed from the Internet and applications downloaded from networks and distribution platforms (e.g., iPhone apps).

The tag interface 120 (e.g., question interface, rating interface, etc.) allows the user 105 to rate and classify the content 115 for the other users 145 and allows the system 100 to better predict future content that is right for the user 105. The tag interface 120 includes an overall rating 150 and one or more tags 125. The overall rating 150 is the user's opinion of the content 115. The tags 125 present the user 105 with various topics for classifying the content 115. The tags 125 can be any descriptive word, phrase, or thing that divides either the content 115 or the user 105 into two or more groups. The tags 125 can include subjective and objective descriptions. The tags 125 can be categorized by their popularity, engagement, frequency of user response, vocabulary, rating time, polarizability, difficulty, etc. A particular type of content 115 can have a database with a few potentially associated tags or a database with thousands of potentially associated tags. This range may depend on the popularity of the content 115. Similarly, a particular user 105 can be asked to rate tags from a database of only a few tags or a database of thousands of tags, or anywhere in between. This range may depend on the level of engagement of the user 105. For example, for a new user, presenting him with one of a small group of tags as the user views different content may be more desirable to keep the process easy and engaging for the new user and develops a broader understanding of the new user's tastes.

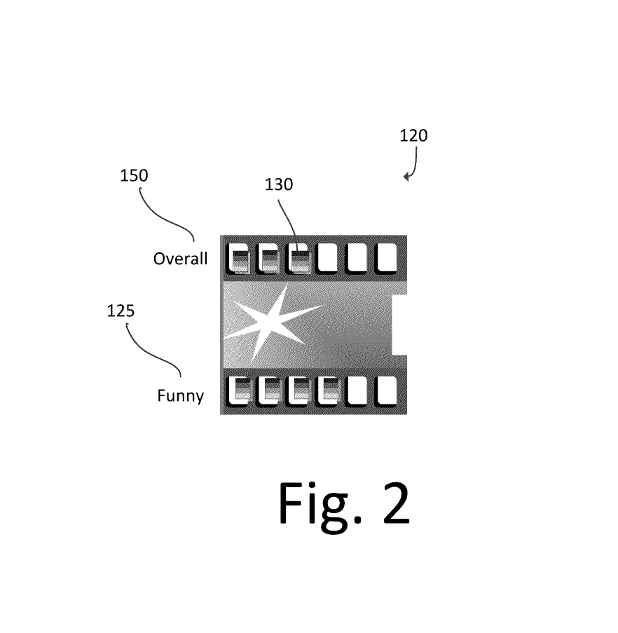

The ratings 130 are a way for the user 105 to evaluate the content 115. The ratings 130 are a way to link the user's overall opinion with a tag describing the content 115. In general, the more ratings 130 that the content 115 receives, the more tags 125 will be generated, the more people the content 115 can be recommended to, and the more popular it will become. Any content that is sufficiently popular typically will be thoroughly tagged such that extremely precise recommendations can be made to others. The tag interface 120 is discussed further with respect to FIG. 2.

The network 135 (e.g., the Internet, a distribution platform, etc.) provides the content 115 to the terminal 110. Also, the network 135 connects the terminal 110 with other terminals 140, such that the classifications can be distributed to other users 145. The network 135 also can comprise a series of servers. The servers can include, for example, a database server having user profiles, a web server for user access, a repository server for storing content 115, and a mail server for communicating with the user 105. The network 135 can process the ratings 130 to better predict what content is right for the user 105 and other users 145.

FIG. 2 illustrates the tag interface 120 in the system 100 according to an embodiment of the invention. The tag interface 120 can be presented on the system's website, a browser extension, a mobile application, a partner's website, and on participating websites. The tag interface 120 can replace or be an improvement for existing application programming interfaces implementing conventional rating techniques.

The overall rating 150 represents the user's overall opinion of the content 115 and an exemplary tag, e.g., funny tag 125, which represents how funny the user found the content 115 to be. The overall rating 150 is designed to be a general question about the content. Although this will typically be whether the user liked the content, the overall rating can be another general question or a question that indicates the user's overall opinion (e.g., if a user thinks the content was funny, it is likely that they liked it overall). The overall rating 150 can come from the tag interface 120, or can from another website (e.g., Netflix) that is integrated with the tag interface 120. The content 115 includes websites, videos, tweets, comments, and more. Some other examples of tags 125 include honest, disturbing, cute, scary, classic, news, announcement, political, profound, encouraging, awww, hilarious, stupid, adorable, ironic, amusing, offensive, creative, crude, sinister, clever, indulgent, fishy, useful, happy, and laugh-out-loud (lol).

The tags 125 can be predefined, and the system 100 can have correlations between the tags, for prediction of the user's opinion of future content. The tags 125 include a word or phrase that will help describe the content 115 and/or provide feedback on a user's opinion of the content 115. The tags 125 also include topics that help predict for other users if that content is right for them and helps predict for the rating user what other content is right for him. The tags 125 may further include sub-tags, which can describe a piece of the content 115, such as an actor's performance within a movie. The rating scale (e.g., 0 to 6) for the overall rating 150 and the funny tag 125 is exemplary only—other rating scales (e.g., 1 to 10) may be used. Rating scales with non-numerical elements are also possible (e.g., small, medium, large, etc.). Likewise, more than one tag 125 may be provided to the user 105.

Typically, the user 105 will rate the tag 125 presented to him. However, the system 100 may provide optional functionality that allows the user to further control the ratings. If the user 105 wishes, the user can change the tag 125. The user 105 can create a new tag or select a different preexisting tag from a database of tags. To change the tag 125, the user 105 can type a description into a text box of the tag 125 presented to him. The text box can have auto-complete features to help the user find a tag. If no existing tag is in the database, an administrator could process and approve the new tag. The approved user generated tag would then be incorporated in a database of tags.

A goal of the system 100 is to be able to predict how other users 145 would rate a tag corresponding to content 115 before viewing the content. This goal can be accomplished by continually asking for more ratings of a particular content, until a statistical confidence, the identification and implementation of which are apparent to one of ordinary skill in the art, is reached. A statistical confidence may be reached based on the number of users that have evaluated the content 115, user agreement, user predictive accuracy, and correlation to other tags that have been evaluated. The system 100 does not want to ask the user more questions than necessary. If the system 100 knows with confidence how a user will rate a tag, or that a user does not want to rate a particular tag, the system 100 does not present the user with that tag. The tag 125 presented to the user 105 can be selected based on the user's interests, or based off other users 145 who have evaluated related tags for the content 115. An example of related tags include a hilarious tag and a laugh out loud (lol) tag, which are both related to comedy. Predictions for a user's rating of a tag can be made by considering a user's rating history, a user's related tag history, related existing tags, implicit user tags, and user similarity to users that have already evaluated the content 115.

In order to learn about new users as quickly and efficiently as possible, users could be asked to evaluate tags they have not previously been shown. The tag 125 presented to the user 105 can be selected in order to confirm an observed correlation to the user 105. The user 105 is presented with tags that can provide useful information about the content 115 to the other users 145.

Depending on how much is known about the content 115 or the user 105, the system 100 can allow more uncertainty for one or another. Additional considerations can be made depending on the popularity or predicted popularity of the content 115, to decide whether the tags 125 should be more focused or more dispersed. More focused tags include asking the other users 145 to rate the same tag or related tags to that rated by the user 105. More dispersed tags include asking the other users 145 to rate a tag that is unrelated to the tag rated by the user 105. For popularity, some content is viewed more than others. For example, a streamed movie may be viewed and rated by a million people, whereas a comment to a news article may be viewed and rated by a hundred people. The scope of the tags generated for the popular movie could be very different than the scope of tags generated for the less viewed comment. By asking for broader feedback related to content that is expected to be viewed less, this avoids creating gaps in feedback that could have been filled by asking better questions.

Another goal of the system 100 is to maximize the value of the data being collected. The collected data includes the ratings 130 for the tags 125 and overall rating 150. By collecting a user's overall rating 150 that can be linked to the collected tags 125, better data is collected. The tags 125 provided to the user 105 can be intelligently selected by, for example, semantic analysis, sentiment analysis, natural language processing, metatags, keywords, generic subjective tags, user browsing behavior, user tagging behavior, creator history, manually by the creator, manually by the administrator of the host website, by the user 105, by the other users 140, or by the first users to tag the content 115.

For example, if the content 115 receives a good overall rating 150, the content 115 must have some combination of favorable qualities that can be tagged. To determine which qualities are favorable, the system 100 can have various lists of specific tags for different types of contents. The other users 145 can help the system 100 determine why the content 115 received the good overall rating through evaluating the specific tags in a tag list. Some tags could swing non-consistent users one way or another, based on the tag description, and may not be ideal for content that has not received many ratings. Instead, tags in the tag list that reliably predict whether other users will enjoy the content are more useful. The tag list can include approved tags and possible tags. The approved tags have already received user input to confirm that the tag belongs in a particular tag list. The possible tags, on the other hand, require additional user input to confirm whether the tag belongs in a particular tag list.

Tags 125 can also be selected by their degree of user engagement, and the likelihood that a user will feel compelled to provide an accurate rating 130. For example, more difficult tags can be reserved for more advanced and engaged users, since ideally tagging should be reflexive, quick, and easy for all users. A tag's difficulty can be measured by the vocabulary difficulty and time required to accurately respond to the tag. For example, vocabulary difficulty may include hip slang tag such a “lol,” which may not be clear to older users. Also, a tag that requires research or thought would take longer to respond to than a tag that requires an impulse response or an easy answer.

The significance of the tags 125 can be determined algorithmically based on rating patterns and related tag ratings. For example, a tag may be deemed more significant if a higher percentage of related tags are rated high. Significance can be determined by a tag graph, where the amount, type, and distance of connections between two members/tags determine the relationship between members/tags. Less significant tags fail to provide a useful distinction between various content. Less significant tags for the content 115 can be filtered out by the system 100, such that the more significant tags remaining are adjusted in priority. Although some established tags are fairly well understood because they are consistently used across different types of content, the significance of the establish tags can be fined tuned by comparing them to the tags related to them. Tag relationships can be determined ontologically, semantically, experimentally, and statistically. When a particular tag is rated high, related tags can be tied to the content 115 as well.

The system 100 builds a list of implicit tag ratings for the user 105, predicting what rating the system expects the user 105 to give based on the correlation between previous overall ratings and previous tag ratings for similar content. The system 100 can also extrapolate a comprehensive tag rating based on other users 145 with the same overall rating, and user tag rating, implicit user tag rating based on history, tag rating from similar users, implicit ratings from similar users based on history. The system 100 can determine a level of contribution from each tag towards the tag rating, determine similar users based on similar overall ratings and tag ratings, and rank tags 125 by contribution significant. Similar users can be determined by similar overall ratings, then adjusted based on tag rating correlations, popularity, and engagement rates.

The overall rating 150 for a tag 125 can be used to relate the user 105 to other users 145, along with determining the quality of the content 115. The overall ratings 150 can affect the type of tags that are suggested in the future. It is important to consider that the tag presented to the user 105 may affect the user's opinion for overall rating 150, and the overall rating 150 may affect the user's rating of the tags 125. As such, the tag interface 120 may pop after the overall rating 150 has been selected, and vice versa.

The ratings 130 show three of six for the overall rating 150 and four of six for the funny tag 125. The ratings 130 can be presented in other formats, such as stars, likes/dislikes, yes/no, etc. For example, after the user 105 is presented with a scary movie, the user 105 can be presented with a tag of scary. Then, the user 105 can answer either yes or no or none to six stars to help classify this movie and compare this movie to other scary movies. The scary tag also helps the system 100 determine why the user liked or disliked the overall movie. Also important, the link between the scary rating and the overall rating 150 indicates how much the user 105 likes or dislikes scary movies. For example, a user voting six stars for the scary tag, but one star for the overall rating, indicates that the user probably does not like scary movies.

By presenting the user with a scary tag, the system 100 splits the user 105 and movie into different groups based on the response and increases the correlation to a subset of the other users 145 with similar rating history. By presenting the user 105 with the scary tag, the system 100 presents the user with a predicted emotional response to a scary movie and allows the user 105 to be critical of the subject matter.

The system 100 provides benefits to the user 105, in that the user 105 receives more personalized future recommendations, access to the tags 125 from other users 145, and the user 105 is given complete control over what information the system 100 tracks. The future recommendations are more personalized because the system 100 asks for feedback from a variety of tags. Every time the user 105 provides feedback, the system 100 gains a better understanding of the user's preferences, and provides more accurate predictions for the user 105. The system's simplicity and incentives encourage the user 105 to continue to provide additional ratings. Also, the tag interface 120 may resemble a game mechanic to encourage participation.

The data is mostly obtained in aggregate from multiple users, because it is collected in piecemeal fashion. Since each user is supplying only a portion of the ratings required to form an accurate prediction, it means the most rated content will be categorized best.

The system 100 benefits not only the users and website owners by allowing the users to receive more personalized content, but also allow the users to receive more personalized advertisements. The information also provides market research for advertisers to select better ads in the future. In one embodiment, users are given control over the types of advertisements they are given. In this way, users can select ads that match their interests. For example, a user interested in movies and cars may be interested in seeing the newest movie release trailers and the newest car model advertisements, which benefits both the consumers and merchants.

The system 100 also provides benefits to the website owners choosing to add the tag interface 120 onto their website. The system 100 improves the user interface with the website by providing a feedback option that is easier than writing a comment, but more meaningful than simply liking or disliking a page. It is estimated that an article would receive at least twice as many ratings 130 as comments, because of the simplicity of the tag interface 120, combined with compelling incentives and respectable conversion ratios to follow-up ratings.

Conventional systems get about 1% of the users to comment, since about 10% of the users rate content and about 10% of them comment. This is sometimes known as a power law, as the drop off happens due to the extra effort demanded. In other words, it is easiest to do nothing in response to a question, followed by making a click response, followed by typing a comment response. This is also known as the 1/9/90 rule. In contrast, the system 100 is simple, rewarding, and effective, which dramatically increases user feedback. Follow up ratings fill in the gap between a rating (10%) and a comment (1%) because a few additional ratings are still easier than a comment.

The tag interface 120 provides a form of feedback which can tell website owners how users perceive their content. Then, the website owners can provide targeted advertising and may better promote certain content. This can give website owners the data they need to personalize content for users. Also, the system 100 can generate tags 125 that make the content 115 easily sortable and structured without any input needed from the website owners. It is also a way to attract new visitors that are looking for the type of content under the unique tags used by the system 100. The system 100 provides a comprehensive rating system, by combining the segmented ratings from users. The system 100 can be integrated together with an existing rating system or can replace the existing rating system used by a website. Additional insights can also be generated for website owners by treating the system as a form of active user analytics where specific feedback can be solicited, measured, and coupled with feedback mechanisms. This is compared to passive user analytics that only monitor behavior and do not directly interact with users.

The system 100 improves on simple systems, such as like/dislike system, since an average like/dislike rating is not very informative or good at predicting whether content is right for a future user. It is also difficult to impossible to quantify what a like means from a business perspective because it is too vague. Also, like/dislike systems have weak incentives, such that the user lacks motivation to provide ratings since there is little direct benefit to the user but only social incentives.

The system 100 also improves on more informative feedback systems, such as written reviews or comments, as these take a considerable effort to write or create an algorithm for, so most content is not reviewed by many, if any, users. Also, since the amount of effort put into comments varies significantly, combined with the small number of comments, the predictive value is low. Further, the users that take the effort to make a comment tend to have opinions that do not represent the opinions of most other users. Instead, these users tend to have opinions that are more extreme. Additionally, comments and reviews are more difficult and time consuming to process algorithmically by a system.

The system 100 systemically generates useful tags 125 for any online content that can be used to build sophisticated categorization, recommendation, and feedback systems that would benefit users, websites, the Internet at large, and the system 100 itself. The system 100 is simple enough that users are more willing to answer the questions such that the content 115 is continuously tested and redefined.

Tag information, both potential and actual, for users and content can be stored in a graph or multi-dimensional matrix. The overall rating 150 is also stored by the system, and used to predict which content is right for which users, and as such, can be considered a special type of tag. When the overall rating is called a tag, the system would prompt the user for two or more tags. The prompted tags can be displayed either together or subsequent to one another. The tags 125 can be represented graphically, symbolically, or in an audio and/or visual manner (e.g., sound effects, smiley faces, weather pictures, etc.).

The system 100 may further include a skip button (not shown) in the tag interface 120. The skip button allows users to avoid rating a particular tag. This would further simplify the system 100, such that the user 105 would not have to think if a difficult tag is presented. Instead of a skip button, the skip feature can be implemented through another type of button (e.g., a “maybe” button, a “meh” button, etc.) or implemented by the passage of a predetermined amount of time.

The system 100 uses the collected data to make recommendations to the other users 145 based on what the system predicts the other users would provide for an overall rating. The system 100 can be implemented in various ways, the mathematic implementations of which are apparent to one of ordinary skill in the art. For example, the system 100 can apply weight to each user tag and multiply the weight against the content rating to get an estimate on a value for the content. The system 100 can further compare the users that have already rated a particular content and relate the users using vector and matrix comparison techniques.

The system 100 may also include a feedback mechanism as part of the recommendation process, such as a confidence score (not shown) on the tag interface 120. The confidence score shows the system's confidence in modeling the user's behavior. A high confidence score indicates that the user is likely to agree with the rating of the recommended content, whereas a low confidence score indicates the system is uncertain how the user will rate the recommended content. As the user rates more content, the confidence in predicting the user's preferences typically increases. The confidence score for a particular content can be different for every user, and can change every time a user makes a rating. The system's confidence score would increase user engagement because the user 105 would be able to see that the system 100 provides better recommendations as the user 105 rates more content. The system 100 can show the user 105 the confidence scores over time for a particular content, indicating that confidence scores typically increase as more of the other 145 users rate the particular content and the user rates more content. The confidence score can include a percentage, a number, a symbol, a textual rating, etc.

The system 100 can be thought of as a personalized data collection feedback loop, making it now simple for many users to provide meaningful feedback and receive better recommendations. The ratings and recommendations of the system 100 can be combined with other systems to take into account the features and existing recommendations of the other systems.

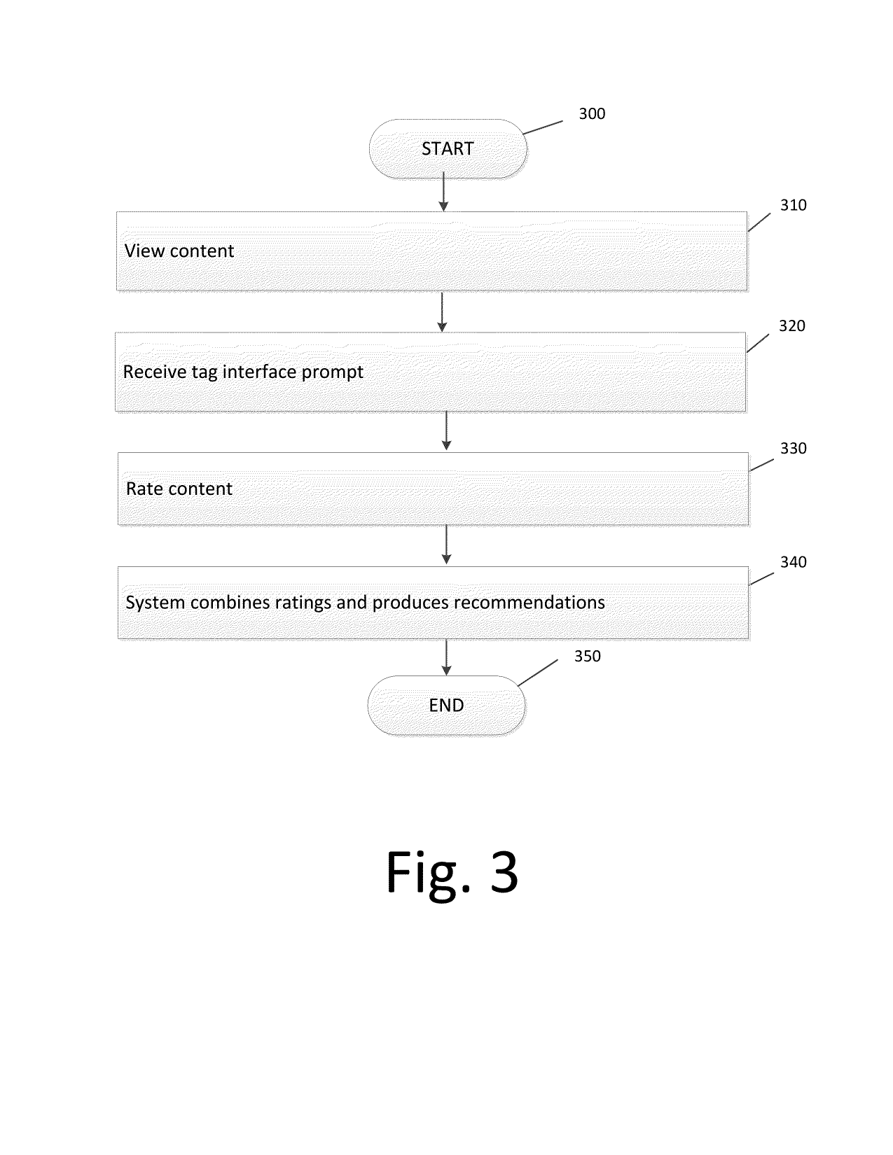

FIG. 3 illustrates a process of rating content according to an embodiment of the invention. The process starts at step 300. At step 310, the user 105 views the content 115. The content 115 may be, for example, a YouTube video, Twitter tweet, or website. Next, at step 320, the user 105 receives the tag interface 120 prompt. Then, the user 105 rates the content 115. The user 105 may rate the content 115 with an overall rating 150 and at least one tag 125. The system 100 combines the ratings 130 and produces recommendations or other forms of feedback/incentives at step 340. The recommendations can be for future content for the user 105, and can be recommending the content 115 to a subset of the other users 145. The process ends at step 350. The process may be repeated iteratively in a loop such that the user can continue to add more ratings and feedback until the user decides to stop.

In one embodiment, the user 105 watches a YouTube video on kittens. Then, the system 100 asks the user 105 to provide ratings 130 of one to six stars for an overall rating 150 and a funny tag 125. The system 100 does not need to collect additional tags from the user 105, since the funny tag can be combined in the system 100 with the ratings of the other users 145, to form comprehensive categorizations and predictions for the content 115. The funny tag 125 may be replaced by another tag (e.g., cute, offensive, silly, etc.). In one embodiment, as opposed to asking the user 105 for 20 unique tags about the content 115, the system 100 asks 20 unique users to each rate one unique tag.

The steps of a method or algorithm described in connection with the embodiments disclosed herein may be embodied directly in a computer or electronic storage, in hardware, in a software module executed by a processor, or in a combination thereof. A software module may reside in a computer storage such as in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a mobile station. In the alternative, the processor and the storage medium may reside as discrete components in a mobile station.

The system 100 can have further uses and features, such as an e-commerce use, use of third party applications, active user analytics, customized content recommendations, profile-based interactions, options/uses for the tags, online reputation system, etc. In the e-commerce use, the system 100 can collect user feedback after an online purchase. After the purchase, the user receives a confirmation email which provides the user with the ability to start the rating process.

In the third party application use, the system 100 may have applications for gift giving, collaborative decision making (e.g., restaurant selection for a group), editorial reputation, compatibility matching (e.g., dating, hiring), and other applications. These applications could be offered by a third party through an API and be based on user consent.

In active user analytics, the analytics engage the users to volunteer information that cannot be determined through passive observation, as passive user analytics measures the way users interact with the site normally.

In customized content recommendations, the system 100 can allow the users to customize their recommended content to require or exclude certain content (e.g., filter restaurants by romantic). The recommendations can be made transparently since they are based on tags that are understandable by users. This also means that users can refine their recommendations by adjusting the significance of specific tags. For example, a personalized music station could be altered to play happier or sadder songs without the need to re-learn every other musical preference. This allows a user's profile to carry over at least in part from one type of content to another. The system 100 can generate new contextual profiles in these situations if these changes significantly alter baseline preferences.

In profile based interactions, the user can create full or partial profiles that can be shared publicly or privately that other users could interact with. The profiles would allow other users to see what content/products would be recommended to that particular user. There can also be generic profiles so new and existing users can receive recommendations and content (e.g., sports fanatic, tech-savvy college student, etc.). The profiles help personalize the user's web experience, through their content, layout, and other features.

The system 100 can have options/uses for the tags. The system 100 can display the tags that are significant to a recommendation alongside results so users understand the context and can adjust it if necessary.

The system 100 can use key tags, or content with similar ratings, to link content rated at different sites. This may be helpful for retail goods sold at different locations but which use the same rating system. In this case, the tags referencing the product would be separated from those referencing the seller. The tags should theoretically converge if the same content is tagged at different locations even though some differences are expected due to context.

The system 100 can monitor the user's reactions to specific tags via audio, visual, neural or other methods, where the system measures the user's immediate response upon being presented with a tag.

The tags can be randomly assigned. Randomly assignment tags makes it difficult for third parties to try to trick the system into making bad recommendations because there is no guarantee which tags will be prompted. This also makes it difficult for bots to participate because their behavior would stand out over time and could be tested explicitly if anomalous behavior is detected by the system. In addition, tags generated by suspicious accounts can be tracked and dealt with. Even if false ratings are generated for content, as soon as a user with a good reputation produces a rating that counteracts the false ones, the influence of the false ratings drops dramatically.

In one embodiment, the criteria for selecting which tag to present to the user is as follows. A group of tags are referred to as important tags. If the content lacks a sufficient number of ratings for important tags, the user is provided with one of the important tags. If content has a sufficient number of important tag ratings, the user is provided with a tag which the system has a low certainty or confidence what the response will be. The reason for this is that the system wants to learn about the user and the content, and if there is uncertainty regarding a particular tag, the system wants to gain a higher confidence about this tag.

In another embodiment, a tag is presented to a user because an administrator, a website owner, or the system has prioritized that tag or a group of tags. The system allows the website owner to add questions/tags. As a result, the website owner gains more insightful analysis from the user ratings. In one embodiment, the user is presented with only positive or neutral tags to rate. This prevents a negative bias towards the website content. The presentation of the question can affect the user's answer for that question. Depending on how a question is presented (e.g., different font sizes, box sizes, underlined, bolded, images, symbols, etc.), affects how the user answers. A subtle variation in presentation also makes the system seem more interesting even though it may be a very simple system. For example, a graphical representation of a smiley face, as opposed to a “like” symbol, may increase user engagement because of the ease of use.

In one embodiment, a user can have a trust or connection to another user. This trust is created when these two users agree on a rating. The more specific tag ratings, the higher the likelihood that the users have the same opinions. Further, the more times the users agree about a tag, the more they can trust each other. Users could also choose to trust other users based on social connections, professional connections, or reputations, trust in these designated users can have specific scopes (e.g., movies, Mexican restaurants, finance, etc) and their contributions to recommendations can be given extra weight.

These trusts can result in more detailed recommendations. When two users have a trust, the system can recommend the content based on the recommendations of trusted users. These ratings can be combined into a detailed recommendation similar to how tags are converted into questions. By extracting several of the strongest connections and converting them into sentences, the system is able to explain why a user might like the content. This is a form of multi-dimensional collaborative filtering. This type of detailed recommendations could be combined with other recommendation systems in whole or in part. For example, Netflix could recommend a movie as 4 stars which would be supplemented with an explanation of why the user might like the movie. Alternatively, a user's ratings could be expanded into a more detailed review to share with others using the same recommendation system.

The tags used to recommend content can be selected based on other criteria such as their persuasiveness to the individual since some of them might be subconsciously influential, repetitive, or there might be other considerations.

The tags can also be generated through natural language processing (NLP) of related content such as source material, reviews, comments and tweets. The related content can also be crowd-source, which is used to create tags/questions. This can identify words/phrases of interest that can be used as additional starting points to collect ratings from users.

The tags can be phrases or questions. The system generates the questions from the phrases. For example, the contextual tag “movie-story-good” becomes “was the movie's story good?” based on the grammatical properties of the tags and sub-tags. The questions can be conversational questions.

The system can contain several variations of similar tags or questions. The questions can judge the intensity of user's feelings to toward something. For example, the question can be “do you like it?” or “do you love it?” By varying the scales of intensity of the questions, the rating question can be varied to change the values associated with an answer. Additionally, different forms of the question can be used, such as “did you like X?” vs “didn't you like X?” vs “you liked X, right?”

The tags can be integrated or embedded into an existing website by a popup or other display mechanism. The popup can include the overall rating and a tag rating. Alternatively, the existing website can have an overall rating and the popup can include the tag rating.

The rating scale for tags can be either absolute (e.g., no, yes), quantized (e.g., 0, 1, 2), percentage (e.g., 0%, 50%, 100%), or whatever else makes the most sense for a particular tag. An example is the number of spelling errors (e.g., 0, 1, 2, a lot).

The system 100 can display collected tag information on other websites. For example, the content tag information that is collected from users can be directly displayed on an external site in anonymized, public, or hybrid form, using standard procedures for third party integration or it can be processed through the external site.

The tags can be represented as graphs, where user feedback refines the content graph over time. In such a system, the tags that produce the more significant differentiation would appear closer and be asked first, while tags relevant to a small minority would be farther away. The graphed tags associate the content and with the users. An interest graph is an often referenced term describing a representation of a user's interests and their interconnections. A taste graph is a more specific and detailed version of an interest graph. A tag graph is generated for content with user feedback. The tags can be represented in a seeding tag graph, or tag list, with tags containing tags from previously tagged related material.

The system provides user incentives to encourage users to continue to rate content. One incentive is a progress indicator. The progress indicator can be used to indicate the number of ratings by a user and a corresponding incentive. The progress indicator can also show the number of ratings given for content along with the expected number of ratings for the content, showing progress as the user adds a rating. Part of the idea is that the user can see that their rating is making a difference. This helps combat the feeling that “my one vote doesn't matter”.

Another incentive can be providing the user feedback, such as a contextual follow-up questions (demonstrating understanding for the previous answer), polls, statistics, badges, achievements, recommendations, rewards specified by the site owner, etc. Better feedback mechanisms increase the number of ratings that users will provide. Users can also be notified about how important their ratings are by calculating how many times they were used in recommending content while factoring in their overall contribution. This lets users know that their ratings mattered to other users which validates their contribution. Varying the type of reward can also help keep users engaged. All forms of feedback can optionally be rated by the user.

This feedback or follow up question can include different questions types. For example, the follow up question can be multiple choice, a comparison between two movies, an unstructured question, an open ended question (i.e., requiring a text response), asking the user to compare the qualities between two contents, custom questions, etc. These structured follow-up questions supplement the data being collected from tag rating. New users can more easily teach the system their preferences via multiple follow up questions on a few instances of content (e.g., 2 or 3 movies), as opposed to one question a very high number of content (e.g., 10 movies), since there are fewer context switches.

A user can agree or disagree with a recommendation by the system. Agreement with a detailed recommendation implies agreement with the tags/ratings it is composed of. However, a user could optionally disagree with a recommendation in whole or in part and correct the recommendation by correctly rating the tags referenced in the recommendation.

In one embodiment, the number of tags that may be presented to the user increases as content gains more total tag ratings. The interface can display tags sequentially to the user, where each additional rating is optional. There is no penalty for the user stopping rating tags early. However, the user can actively choose to rate content an additional number of times. The progress indicator can be adjusted the total projected number of ratings based on the likelihood of that content being rated. Also, a tag is less likely to be presented if the system is already confident of the user's answer compared to if the system is uncertain about how the user will answer when presented with a particular tag. The stronger the user's opinion on the content, the more likely the user will want to answer more questions.

In another embodiment, the system includes the overall rating just like any other tag establishing content. Here, the system immediately prompts the user for a tag rating, followed by feedback from the system (e.g., acknowledgement, statistics, recommendations, etc.). This process may be repeated 1-3 times where each rating simultaneously splits the content and the users into a plurality of groups. Each successive tag rating may be selected to be narrower in scope than the previous tag, such that the system can more accurately categorize the content and add context to the proceeding rating. This system can be combined with other existing rating systems. The system 100 can act like a cloud network so users can access their rating profile and rate content on multiple websites online.

It is to be recognized that depending on the embodiment, certain acts or events of any of the methods described herein can be performed in a different sequence, may be added, merged, or left out altogether (for example, not all described acts or events are necessary for the practice of the method). Moreover, in certain embodiments, acts or events may be performed concurrently, for example, through multi-threaded processing, interrupt processing, or multiple processors, rather than sequentially.

The users can have a name that is displayed along with their rating. The name can be the user's real name, pseudo name, anonymous, or unregistered. The user's real name is their birth name. The user's pseudo name is any nickname that they choose. An anonymous name is registered and known by the system, but not by the public. The unregistered name is neither known by the public or the system. The user's preferences allow the user to choose between these four types of account names for any particular content, content type or content site. For example, a user may use a real name for movie reviews, a pseudo name for restaurant reviews, and an anonymous name for political reviews. Users can have the ability to restrict their recommendations and feedback to certain types of users. Name preferences could be automatically configured based on the preferences of similar users.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A system comprising:
software for providing a tag interface on a terminal for rating the content, the tag interface comprising an overall rating and a tag rating collected from the user, wherein the overall rating gives the overall opinion of the user of the content, wherein the tag rating classifies the content into at least one of a plurality of groups providing feedback about the content, wherein a connection between the tag rating and the overall rating classifies the user into at least one of a plurality of groups providing feedback about the user, wherein a combination of the tag rating of the user with one or more tag ratings of other users further classify the content into at least one of a plurality of groups piecing together a larger understanding of the content.

2. The system of claim 1, wherein the tag rating consists of no more than one rating paired with the overall rating.

3. The system of claim 1, wherein the tag rating consists of no more than two tag ratings paired with the overall rating.

4. The system of claim 1, wherein the tag rating comprises more than two tag ratings paired with the overall rating.

5. The system of claim 1, further comprising one or more follow up questions.

6. The system of claim 1, wherein the tag rating comprises at least one of: funny, honest, disturbing, cute, scary, classic, news, announcement, political, profound, encouraging, hilarious, stupid, adorable, ironic, amusing, offensive, creative, crude, sinister, clever, indulgent, fishy, useful, happy, and laugh-out-loud (lol).

7. The system of claim 1, wherein the tag rating is subjective or objective.

8. The system of claim 1, wherein the tag rating organizes the content or the user such that better recommendations or predictions can be made regarding the content or the user.

9. The system of claim 9, wherein the recommendations or predictions are provided to the user, other users, or a website owner.

10. The system of claim 9, wherein the recommendations are based on the tag rating of the user.

11. The system of claim 1, wherein the user changes the rating tag to one of the user's choice.

12. The system of claim 1, wherein the rating tag is selected by its degree of user engagement.

13. The system of claim 1, further comprising a skip button configured to skip the tag rating.

14. The system of claim 1, further comprising a confidence score predicting the opinion of the user related to the content.

15. The system of claim 14, wherein the tag rating presented to the user is selected based on the confidence score.

16. The system of claim 1, wherein the tag rating comprises a question.

17. A method comprising:
receiving content from a network;
receiving the content at a terminal connected to the network, the terminal configured to display the content from the network to a user; and
receiving a tag interface on the terminal for rating the content, the tag interface comprising an overall rating and a tag rating collected from the user, wherein the overall rating gives the overall opinion of the user of the content, wherein the tag rating classifies the content into at least one of a plurality of groups providing feedback about the content, wherein a connection between the tag rating and the overall rating classifies the user into at least one of a plurality of groups providing feedback about the user, wherein a combination of the tag rating of the user with one or more tag ratings of other users further classify the content into at least one of a plurality of groups piecing together a larger understanding of the content.

18. The method of claim 17, wherein the tag rating consists of no more than one rating paired with the overall rating.

19. An apparatus comprising:
a tag interface on a terminal for rating content;
an overall rating collected from a user on the tag interface; and
a tag rating collected from the user on the tag interface,
wherein the overall rating gives the overall opinion of the user of the content, wherein the tag rating classifies the content into at least one of a plurality of groups providing feedback about the content, wherein a connection between the tag rating and the overall rating classifies the user into at least one of a plurality of groups providing feedback about the user, wherein a combination of the tag rating of the user with one or more tag ratings of other users further classify the content into at least one of a plurality of groups piecing together a larger understanding of the content.

20. The apparatus of claim 20, wherein the tag rating consists of no more than one rating paired with the overall rating.
